(19) United States
(12) Patent Application Publication
(10) Pub. No.: US 2023/0127140 A1
(43) Pub. Date: Apr. 27, 2023

(54) PULSE PROTEIN EMULSIFIERS

(71) Applicant: CORN PRODUCTS DEVELOPMENT, INC, WESTCHESTER, IL (US)

(72) Inventors: Quyen NGUYEN, Bridgewater, NJ (US); Brandon ROA, Bridgewater, NJ (US); Bicheng WU, Bridgewater, NJ (US); Xin YANG, Bridgewater, NJ (US); Christopher ZHANG, Bridgewater, NJ (US)

(21) Appl. No.: 17/801,569

(22) PCT Filed: Mar. 1, 2021
(86) PCT No.: PCT/US2021/020276

§ 371 Date: Aug. 23, 2022

Related U.S. Application Data
(60) Provisional application No. 62/984,119, filed on Mar. 2, 2020.
(60) Provisional application No. 63/116,593, filed on Nov. 20, 2020.

(51) Int. Cl. A23L 11/00; A23D 7/005; A23L 29/10

(52) U.S. Cl. CPC A23L 11/05; A23D 7/0053; A23L 29/10

(57) ABSTRACT

The technology disclosed in this specification pertains to pulse protein-based emulsifiers comprising unhydrolyzed soluble pulse, or pea, or chickpea protein and a dissolved, unmodified amylopectin. Also disclosed in this specification are long term shelf stable egg-free emulsions and methods of their manufacture using the described pulse protein-based emulsifiers. Stability of the emulsion can be measured by reference to their small mean oil droplet size and reduced variability in mean oil droplet size over time.

This specification discloses emulsifiers comprising an unhydrolyzed soluble pulse, pea, or chickpea protein and a dissolved, unmodified amylopectin. Also disclosed in this specification are long term shelf stable egg-free emulsions and methods of their manufacture using the described pulse protein-based emulsifier.

Common emulsifiers used in emulsions include monoglycerides, diglycerides, egg yolks, and modified starches such as octenyl-succinic acid modified starches (OSA-starches). Such emulsifiers may be disfavored in some uses as not being clean label (because they are chemically modified substances) or being from animal sources. Unmodified plant-based emulsifiers from various sources have been explored as replacements for animal based or chemically modified emulsifiers, but commonly not as effective at stabilizing the oil and water emulsion from separating, especially over long periods of time. A need exists, therefore, for methods and compositions that extend the shelf-life of emulsions made with plant-protein based emulsifiers, and particularly for pulse protein-based emulsifiers.

### BRIEF DESCRIPTION OF THE FIGURES

The technology described in this application can be better understood with reference to the following non-limiting figure.

FIG. 1 shows the mean oil droplet size over time of an oil-in-water emulsion containing a cooked highly thermally inhibited starch.

FIG. 2 shows the mean oil droplet size over time of an oil-in-water emulsion containing a cooked intermediately thermally inhibited starch.

FIG. 3 graphs the oil droplet size (y-axis) versus unhydrolyzed soluble pulse protein wt.% content (x-axis) in gelatinized amylopectin free oil-in-water emulsions.

FIG. 4 graphs the oil droplet size (y-axis) versus gelatinized amylopectin wt.% content (x-axis) oil-in-water emulsions made using aqueous unhydrolyzed soluble pulse protein emulsifier having 0.45% protein content (w/w).

The technology disclose in this specification pertains to a pulse protein-based emulsifier composition comprising: an unhydrolyzed soluble pulse, or pea, or chickpea protein in an amount of about 1% to about 3% of the emulsifier mixture; and a dissolved unmodified amylopectin in an amount of about 2% to about 5% or from about 3% to about 4% of the emulsifier mixture; wherein the composition is an aqueous composition. In some embodiments of the pulse-protein based emulsifier, the amylopectin is selected from the group consisting of waxy corn, waxy tapioca, waxy rice, and waxy potato and mixtures thereof.

In any embodiment described in this specification, a pulse protein-based emulsifier having a total solids content of from about 5% to about 15% or from about 5% to about 10%.

In any embodiment described in this specification, a pulse protein-based emulsifier does not comprise a hydrocolloid or modified starch. In any embodiment described in this specification, a pulse protein-based emulsifier does not comprise adding a starch other than the solubilized amylopectin.

In any embodiment described in this specification, consists essentially of an aqueous chickpea protein solution, and the amylopectin. In any embodiment described in this specification, consists essentially of an aqueous pea protein solution, and the amylopectin.

Also disclosed in this specification are methods of making an an aqueous pulse protein-based emulsifier composition comprising: obtaining a mixture comprising: i) an aqueous solution comprising an unhydrolyzed soluble chickpea protein or pea protein, in an amount of about 1% to about 3% of the emulsifier composition; and ii) an unmodified gelatinized amylopectin in an amount of about 2% to about 5% or from about 3% to about 4% of the emulsifier composition; wherein, preferably, the unhydrolyzed soluble protein is a pea protein.

In any embodiment described in this specification a method for making an aqueous pulse-protein based emulsifier composition further comprises obtaining the mixture by mixing the aqueous solution comprising the unhydrolyzed soluble chick pea protein or pea protein with an unmodified amylopectin and heating the aqueous solution at a temperature of from about 90° C. to about 100° C. for at least about 15 minutes, or at about least 20 minutes, so that the amylopectin is gelatinized and dissolved in the aqueous solution.

In any embodiment of a method for making an aqueous pulse protein based emulsifier composition described in this specification, the aqueous solution comprising an unhydrolyzed soluble protein has a Brix of from about 5° to about 10°, or from about 5° to about 9°, or from about 5° to about 8°, or from about 5° to about 7°, or from about 6° to about 8°, or from about 6° to about 9°, or from about 6° to about 8° Brix.

In any embodiment of a method for making an aqueous pulse protein-based emulsifier composition described in this specification, the composition has total solids content from about 5% and about 15%, or from about 5% to about 10%.

In any embodiment of a method for making an aqueous pulse protein-based emulsifier composition described in this specification, the method does not comprise adding a hydrocolloid, or modified starch.

In any embodiment of a method for making an aqueous pulse protein-based emulsifier composition described in this specification, the method does not comprise adding a starch other than the unmodified gelatinized amylopectin.

In any embodiment of a method for making an aqueous pulse protein-based emulsifier the unhydrolyzed soluble plant protein is a pulse protein, or a pea protein or a chickpea protein. Unhydrolyzed soluble pulse protein, or pea protein or chickpea protein may be obtained from whole or split pulse, pea or chickpea or from a pulse, or pea, or chickpea flour. It may be obtained by any process including as part of a process used to extract protein from a pulse flour, pea flour, or chickpea flour. In any embodiment the unhydrolyzed soluble pulse, or pea, or chickpea protein is provided as an aqueous solution, which may comprise pulse, pea, or chickpea components other than protein. In some embodiments the unhydrolyzed soluble plant protein is from a process that steeps or that cooks pulses or pulse flour, or peas or pea flour, chickpeas or chickpea flour in water and then discards the solid components and retains the steep water. Such steep water is expected to contain components from the pulse, pea or chickpea other than unhydrolyzed soluble protein, like starch or fiber.

In some embodiments the emulsifier comprises unhydrolyzed soluble protein provided by chickpea steep water and comprising some chickpea starch the starch generally comprises both amylose and amylopectin. The chickpea starch may be gelatinized during the process of obtaining the chickpea steep water. It has been observed that emulsion made using chickpea steep water form unstable emulsions that are not long-term stability against oil separation without the addition of dissolved amylopectin. In any embodiment of an emulsion described in this specification, dissolved amylopectin is an added component that is different than and in addition to the any amylopectin from chickpea.

In any embodiment of a method for making an aqueous pulse protein-based emulsifier composition described in this specification, an unhydrolyzed soluble chickpea protein is provided by chickpea steep water. In any embodiment of a method for making an aqueous pulse protein-based emulsifier composition described in this specification, an emulsifier mixture used in the emulsion is obtained or obtainable by heating a granular amylopectin in chickpea steep water for enough time to gelatinize the amylopectin. In any embodiment of a method for making an aqueous pulse protein-based emulsifier composition described in this specification, comprises heating the chickpea or pea or pulse steep water and amylopectin at a temperature of from about 90° C. to about 100° C. for at least about 15 minutes, or at about least 20 minutes. In other embodiments described in this specification the emulsifier mixture is obtained or obtainable by mixing a gelatinized amylopectin with chickpea steep water. In any embodiment of a method described in this specification the unhydrolyzed soluble chickpea protein steep water has solids content measured in Brix of from about 5° to about 10°, or from about 5° to about 9°, or from about 5° to about 8°, or from about 5° to about 7°, or from about 6° to about 8°, or from about 6° to about 9°, or from about 6° to about 8° Brix. In any embodiment of a method described in this specification, an emulsifier mixture comprising unhydrolyzed chickpea protein and dissolved amylopectin has a total solids content of from about 5% to about 15% or from about 5% to about 10%.

In some embodiments described in this specification, an aqueous pulse protein-based emulsifier comprises unhydrolyzed soluble protein provided by chickpea steep water and comprising some chickpea starch the starch generally comprises both amylose and amylopectin. The chickpea starch may be gelatinized during the process of obtaining the chickpea steep water. It has been observed that emulsion made using chickpea steep water form unstable emulsions that are not long-term stability against oil separation without the addition of dissolved amylopectin. In any embodiment of an emulsion described in this specification, dissolved amylopectin is an added component that is different than and in addition to the any amylopectin from chickpea.

In other embodiments described in this specification, an aqueous pulse protein-based is a process water of a pea protein isolation process. Pea protein may be isolated from milled pulse by various methods that separate substantially all starch and fiber from the isolate. Commonly such processes use centrifugation or filtration to recover a generally insoluble pea protein, called an isolated pea protein. The pea protein isolate exists as a precipitate or retentate. The supernatant of the or filtrate, however, retains unhydrolyzed soluble pea protein. The supernatant or retentate may be concentrated to a desired concentration. In other embodiments described in this specification, an aqueous pulse protein-based comprises an aqueous pea protein solution, which in any embodiment has a solids content from about 5° to about 10° Brix, or from about 5° to about 9°, or from about 5° to about 8°, or from about 5° to about 7°, or from about 6° to about 8°, or from about 6° to about 9°, or from about 6° to about 8° Brix

In one aspect the technology disclosed in this specification pertains to long term shelf stable emulsions using a plant-protein based emulsifier. In some embodiments, such emulsions have high oil content. The emulsions described in this specification generally comprise an unhydrolyzed soluble plant protein and dissolved amylopectin. Any embodiment of an emulsion described in this specification does not comprise a hydrocolloid or modified starch. In embodiments disclosed in this specification, an emulsion of oil and water comprises a) an oil in an amount from about 65% to about 80% by weight of the emulsion, or from about 70% to about 80%, or from about 70% to about 75%; b) an unhydrolyzed soluble pulse, or pea, or chickpea protein in an amount of about 0.15% to about 0.55%, or about 0.25% to about 0.45%, or about 0.30% to about 0.40% by weight of the emulsion; c) a dissolved, unmodified amylopectin in an amount of about 0.1% to about 1.0% by weight of the emulsion, or of about 0.2% to about 0.80% (w/w), or from about 0.4% to about 0.8% (w/w), or from about 0.5% to about 0.8% (w/w); and d) an aqueous ingredient; wherein the emulsion is egg free.

In other embodiments, such emulsions are low fat. In some embodiments disclosed in this specification an emulsion of oil and water comprises a) an oil in an amount of from about 25% to about 50% or from about 25% to about 40% or from about 25% to about 35% b) an unhydrolyzed soluble pulse, or pea, or chickpea protein in an amount of about 0.15% to about 0.55%, or about 0.25% to about 0.45%, or about 0.30% to about 0.40% by weight of the emulsion; c) a dissolved, unmodified amylopectin in an amount of about 0.1% to about 1.0% by weight of the emulsion, or of about 0.2% to about 0.80% (w/w), or from about 0.4% to about 0.8% (w/w), or from about 0.5% to about 0.8% (w/w); and d) an aqueous ingredient; wherein the emulsion is egg free.

Any embodiment of the emulsion described in this specification have pH of less than 5 or from about 3 to about 5, or from about 2.5 to about 7. In any embodiment, the emulsions described in this specification have viscosity of from about 10,000 to about 50,000 cP, or from about 15,000 to about 30,000 cP, or from about 15,000 to about 25,000 cP. In any embodiment described in this specification, emulsions have a mean oil droplet size from about 5 microns to about 20 microns, or from about 5 microns to about 15 microns or from about 10 to about 15 microns. Any embodiment of an emulsion described in this specification has a mean oil droplet size of less that changes by less than about 5 microns over 1 month’s storage at one or more of 5° C. or 25° C., or over 6 months storage at those temperatures.

In another aspect, this specification discloses use of an unmodified amylopectin to provide long term stability to an emulsion that comprising a plant-protein based emulsifier, but that does not comprise egg, modified starch or hydrocolloid by dissolving amylopectin in the emulsion. In any embodiment, the use of dissolved amylopectin is as described within this specification. In any embodiment, dissolved amylopectin is used to stabilize an emulsion as described in this specification, and to obtain an emulsion having the properties described in this specification.

In some embodiments the disclosed emulsions obtain commercially useful viscosity and stability without the use of a viscosifying agent such as a modified starch, or gum, or hydrocolloid, but in others, such agents can be used in the disclosed emulsions to increase viscosity, or to provide a desired mouth feel or other desired organoleptic effect. Viscosifying agents such as modified starch, gums, and hydrocolloids can be included in amounts suitable to achieve the desired effect using the selected material. In at least some embodiments an emulsion, as described in this specification further includes modified starch in an amount of from about 1% to about 10%, or from about 1% to about 5%. In any embodiment useful modified starches include physical modified starches such as thermally inhibited starches. Processes for making thermally inhibited starches have various degree of inhibition are described for example in WO95/04082, which is incorporated herein by reference. Other useful starches include chemically modified starches that are, for example, phosphate or adipate cross-linked.

Dissolved amylopectin is distinguished from starches used to thicken an emulsion. In any embodiment of an emulsion described in this specification, dissolved amylopectin does not contribute to the viscosity of the emulsion. In any embodiment of an emulsion described in this specification, dissolved amylopectin is not granular.

In another aspect this specification discloses methods of making long term shelf stable emulsions comprising a pulse-protein based emulsifier. In any embodiment described in this specification a method of making emulsion comprises a) mixing an oil in an amount from about 65% to about 80% by weight of the emulsion, or from about 70% to about 80%, or from about 70% to about 75%; b) an aqueous ingredient, and c) an emulsifier mixture in an amount from 10% to 30% of the of the emulsion, or about 10% to about 25%, or about 15% to about 25%, or about 15% to about 20% wherein the emulsifier mixture is an aqueous mixture comprising: i) an unhydrolyzed soluble pulse or, pea or, chickpea protein in an amount of about 1% to about 3% of the emulsifier mixture; and ii) a dissolved, unmodified amylopectin in an amount of about 2% to about 5% or from about 3% to about 4% of the emulsifier mixture; and wherein the emulsion does not comprise egg. In any embodiment, the method does not comprise a step of adding a modified starch or hydrocolloid.

The technology disclosed in this specification also pertains to long term stable emulsions and method for stabilizing an emulsion, such emulsions may be an edible composition (such as a sauce or dressing or condiment) or may be part of such edible composition. In any embodiment, an emulsion comprises and enough dissolved amylopectin to stabilize the emulsion for up to six months or up to one year. In any embodiment, an edible composition disclosed in this specification is oil-in-water emulsion and enough dissolved amylopectin so that the mean oil droplet size within the emulsion changes by less than about 10%, or less than about 7%, or less than about 5%, or less than about 2% over at least one. In any embodiment, an edible composition disclosed in this specification is an oil-in-water emulsion and comprises enough dissolved amylopectin so that the mean oil droplet size within the emulsion changes by less than about 10% for at least one month, or less than about 7%, or less than about 5%, or less than about 2% when stored at 5° C. In any embodiment, an edible composition disclosed in this specification is an oil-in-water emulsion and comprises enough dissolved amylopectin so that the mean oil droplet size within the emulsion changes by less than about 10% at least 1 month, or less than about 10%, or less than about 7%, or less than about 5%, or less than about 2% when stored at 25° C.

In any embodiment, an edible composition disclosed in this specification is an oil-in-water emulsion and comprises enough dissolved amylopectin so that the mean oil droplet size within the emulsion changes by less than about 5 microns when stored at 5° C. or 25° C. when samples of the emulsion measured for droplet size between 1 week and 1 month, or 1 week and 2 months, or 1 week and 3 months or 1 week and 4 months or 1 week and 6 months. In any embodiment, an edible composition disclosed in this specification is an oil-in-water emulsion and comprises enough dissolved amylopectin so that the mean oil droplet size within the emulsion changes by less than about 5 microns when stored at 5° C. or 25° C. when samples of the emulsion measured for droplet size between 1 week and 6 months, or 1 month and 6 months, or 2 months and 6 months, or 3 months and 6 months, or 4 months and 6 months, or 5 months and 6 months.

In any embodiment, an edible composition disclosed in this specification is an oil-in-water emulsion and comprises enough dissolved amylopectin so that the mean oil droplet size within the emulsion changes by less than 5 microns when stored at 5° C. or 25° C. when samples of the emulsion measured for droplet after 1 month storage, including, for example, but not limited to, comparing samples obtained from the emulsion after 1 month and after 2 months storage.

In any embodiment, an edible composition disclosed in this specification is an oil-in-water emulsion and comprises enough dissolved amylopectin so that the mean oil droplet size within the emulsion changes by less than about 5 microns when stored at 5° C. or 25° C. when samples of the emulsion measured for droplet after 2 months’ storage, including for example, but not limited to, comparing samples obtained from the emulsion after 1 month and after 3 months storage.

In any embodiment, an edible composition disclosed in this specification is an oil-in-water emulsion and comprises enough dissolved amylopectin so that the mean oil droplet size within the emulsion changes by less than about 10% for at least one month, or less than about 7%, or less than about 5%, or less than about 2% when stored at 5° C. or 25° C. when samples of the emulsion measured for droplet after 3 months’ storage, including for example, but not limited to, comparing samples obtained from the emulsion after 3 months’ and after 6 months’ storage.

In any embodiment described in this specification an emulsion of oil and water has mean oil droplet size from about 5 microns to about 15 microns or from about 5 to about 10 microns after 1-month storage. In any embodiment described in this specification an emulsion of oil and water has a mean oil droplet from about 5 microns to about 15 microns or from about 5 to about 10 microns over 1-month when stored at one or more of 5° C. or 25° C. In any embodiment described in this specification an emulsion of oil and water has a mean oil droplet size from about 5 microns to about 15 microns or from about 5 to about 10 microns over 6 months when stored at one or more of 5° C. or 25° C.

In any embodiment, an edible composition disclosed in this specification is an oil-in-water emulsion and comprises dissolved amylopectin in an amount at least about 0.10% of the emulsion (w/w) or at least about 0.15% (w/w), or at least about 0.20% (w/w). In any embodiment, an edible composition disclosed in this specification is an oil-in-water emulsion and comprises dissolved amylopectin in an amount from about 0.10% to about 20.00% (w/w) of the emulsion, or from about 0.1% to about 10%, or from about 0.1% to about 5%, or from about 0.10% to about 0.60% (w/w), or from about 0.10% to about 0.50% (w/w), or from about 0.10% to about 0.40% (w/w), or from about 0.10% to about 0.30% (w/w), or from about 0.10% to about 0.20% (w/w). In any embodiment, an edible composition disclosed in this specification is an oil-in-water emulsion and comprises dissolved amylopectin in an amount from about 0.20% to about 0.70% (w/w) of the emulsion, or from about 0.30% to about 0.70% (w/w), or from about 0.40% to about 0.70% (w/w), or from about 0.50% to about 0.70% (w/w) or from about 0.60% to about 0.70% (w/w). In any embodiment, an edible composition disclosed in this specification is an oil-in-water emulsion and comprises dissolved amylopectin in an amount from about 1% to about 20% (w/w) of the emulsion, or about 5% to about 20%, or about 10% to about 20% or about 15% to about 20%. In any embodiment, an edible composition disclosed in this specification is an oil-in-water emulsion and comprises dissolved amylopectin in an amount from about 1% to about 15% (w/w), or about 5% to about 10%, or about 8% to about 12%.

Emulsions having dissolved amylopectin have smaller oil droplet size compared to emulsions not using dissolve amylopectin. Smaller oil droplet size is a proxy for emulsion stability against oil and water separation. The smaller oil droplet size of emulsions using dissolved amylopectin can also be compared to emulsions not using dissolved amylopectin but having higher protein content. It has been observed that an oil in water emulsion comprising from 0.5% to 0.7% (wt.%) dissolved amylopectin and 0.45% (wt.%) unhydrolyzed pulse protein has oil droplet size of about 6.5 to about 7.5 microns, which is comparable to an emulsion without dissolved gelatinized amylopectin but using about 0.60% (wt.%) unhydrolyzed soluble pulse protein. This shows that use of gelatinized amylopectin in the amounts disclosed in any embodiment of this specification is use either to reduce overall protein usage or ensure emulsions stability when the protein content in an aqueous pulse protein emulsifier is unknown or is variable.

For oil in water emulsions comprising pulse protein emulsifier that oil droplet size decreases within increased total protein content at protein content (w/w) of less than about 0.50%. At protein content between about 0.50% and 0.60% minimum oil droplet size is obtain at between about 5 and 10 microns. Increasing protein content above about 0.70% do not further reduce oil droplet size. Additionally, for oil in water emulsion comprising pulse protein emulsifier and dissolved amylopectin, as protein content remains constant, oil droplet size decrease as amylopectin content increase to a dissolved amylopectin until oil droplet size of between 5 and 10 microns is obtained. Without being bound by theory amylopectin is not acting as emulsifier, meaning it is not stabilizing the oil-water interface. Instead, amylopectin assists the protein in obtaining a minimum oil droplet size, allowing for optimal emulsions to be made with less total protein needed.

Reference to “dissolved unmodified amylopectin” refers to amylopectin that is not in granular form but is otherwise not modified, like by chemical, enzymatic, or physical process, and that has dissolved into solution. Dissolved amylopectin is obtainable from gelatinized starches where the gelatinization process destroys the native granular structure of starch but does not otherwise modify the amylopectin. Dissolved amylopectin may come from gelatinized waxy starches, although methods of separating amylose from amylopectin are known. The amount of dissolved amylopectin may be directly measured according to the methods described in this specification. It also can be calculated based on the soluble content of a pregelatinized starch and the amount of the pregelatinized starch used in an emulsion.

Reference to “hydrolysis” or “hydrolyzed” in this specification means an intentional process used to reduce the size of a protein. Hydrolysis reactions commonly involve acid or enzyme to cleave bonds between amino acid

Reference to the “stability” or “long term stability” of an emulsion means that the oil and aqueous phases of an emulsion do not separate over a claimed period of time. Change in mean oil droplet size over time may be used as a proxy to describe the lack of separation of oil and water as smaller oil droplets more easily remain dispersed with in the aqueous phase and an increase in oil droplet size indicates coalescing of oil and onset of oil separation from the aqueous phase..

Reference to “soluble content” as used in this specification means a percentage of soluble starch that dissolves in aqueous solution.

Reference to “waxy” starch refers to starch from plants (waxy corn, waxy potato, waxy tapioca, waxy rice, etc.) that make starch granules without amylose granule. Such starches may also be called to amylopectin starch because the starch granule consists or consists essentially of amylopectin (have about 0% amylose).

Use of “about” to modify a number in this specification is meant to include the number recited plus or minus 10%. Where ^{legally} permissible recitation of a value in a claim means about the value. Use of about in a claim or in the specification is not intended to limit the full scope of covered equivalents.

Use of “essentially” to modify a number, for example essentially 0, is meant to include minimal amounts of contaminant below a specifically recited amount. The amount of contaminant may or may not be measurable.

Recitation of the indefinite article “a” or the definite article “the” in this specification is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

All publications, patent applications, issued patents, and other documents (for example, journals, articles and/or textbooks) referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The technology is further described in the following aspects, which are intended to be illustrative, and are not intended to limit the full scope of the claims and their equivalents.

1. An emulsion of oil and water comprising: oil in an amount from about 65% to about 80% by weight of the emulsion, or from about 70% to about 80%, or from about 70% to about 75%; an unhydrolyzed soluble pulse, or pea, or chickpea protein in an amount of about 0.15% to about 1.0% or from 0.15% to about 0.55%, or about 0.25% to about 0.45%, or about 0.30% to about 0.40% by weight of the emulsion; dissolved unmodified amylopectin in an amount of about 0.1% to about 1.0% by weight of the emulsion, or of about 0.2% to about 0.80% (w/w), or from about 0.4% to about 0.8% (w/w), or from about 0.5% to about 0.8% (w/w); and an aqueous ingredient; wherein the emulsion is egg free wherein, preferably, the unhydrolyzed soluble protein is pea protein or chickpea protein, and more preferably is a pea protein.

2. The emulsion of claim 1 wherein unhydrolyzed soluble protein is in an amount of about 0.4% to about 0.5% and the dissolved unmodified amylopectin is in amount of about 0.4% to about 0.6%.

3. The emulsion of claim 1 or 2 wherein the amylopectin is from waxy corn, waxy potato, waxy tapioca, or waxy rice.

4. The emulsion of any one of claims 1 to 3 wherein the emulsion does not comprise a hydrocolloid or modified starch.

5. The emulsion of any one of claims 1 to 4 wherein the emulsion does not comprise a starch other than the solubilized amylopectin.

6.The emulsion of any one of claims 1 to 5 having a pH of less than 5 or from about 3 to about 5, or from about 2.5 to about 7.

7. The emulsion of any one of claims 1 to 6 having a viscosity of from about 10,000 to about 50,000 cP, or from about 15,000 to about 30,000 cP, or from about 15,000 to about 25,000 cP.

8. The emulsion of any one of claims 1 to 7 further comprising an amylopectin content in sufficient amount to stabilize an oil-in-water emulsion for up to six months or up to one year.

9. The emulsion of any one of claims 1 to 8 having a mean oil droplet size from about 5 microns to about 20 microns, or from about 5 microns to about 15 microns or from about 10 to about 15 microns, or less than about 10 microns or from about 5 to about 10 microns.

10. The emulsion of any one of claims 1 to 9 wherein the mean oil droplet size within the emulsion changes by less than about 5 microns for at least one month.

11. The emulsion of any one of claims 1 to 10 having a variation of a mean oil droplet size that changes by less than about 5 microns over 1 month’s storage at one or more of 5° C. or 25° C.

12. The emulsion of claims 1 to 11 having variation of a mean oil droplet size that changes by less than about 5 microns over 6 months when stored at one or more of 5° C. or 25° C.

13. The emulsion of any one of claims 1 to 12 wherein the amylopectin is dissolved in an aqueous phase of the emulsion in an amount at least about 0.10% of the emulsion (w/w) or at least about 0.15% (w/w), or at least about 0.20% (w/w) or in an amount of about 0.15% to about 0.55%, or about 0.25% to about 0.45%, or about 0.30% to about 0.40%, or about 0.15% to about 1.0%.

14. Use of a gelatinized but otherwise unmodified amylopectin to provide long term stability to an oil in water emulsion wherein the amylopectin is dissolved in the emulsion in an amount of about 0.1% to about 1.0% by weight of the emulsion, or of about 0.2% to about 0.80% (w/w), or from about 0.4% to about 0.8% (w/w), or from about 0.5% to about 0.8% (w/w).

15. Use as recited in claim 14 wherein the dissolved unmodified amylopectin is in amount of about 0.4% to about 0.6%.

16. The use as recited in claim 15 wherein the emulsion is egg-free and further comprise an unhydrolyzed soluble pulse, or pea, or chickpea protein emulsifier, wherein, preferably the emulsifier is an unhydrolyzed soluble chickpea protein used in an amount of about 0.15% to about 1.0%, or about 0.15% to about 0.55%, or about 0.25% to about 0.45%, or about 0.30% to about 0.40%, or, preferably, in an amount from about 0.4% to about 0.5% by weight of the emulsion.

17. The use as recited in claim 15 or 16 wherein the emulsion is egg-free and wherein the pulse, or pea, or chickpea protein emulsifier in the emulsion is an unhydrolyzed soluble pea protein used in an amount of about 0.15% to about 1.0%, or about 0.15% to about 0.55%, or about 0.25% to about 0.45%, or about 0.30% to about 0.40% by weight of the emulsion, or preferably in an amount from about 0.4% to about 0.5% by weight of the emulsion.

18. The use as recited in any one of claim 15 to 17 wherein the oil is in an amount from about 65% to about 80% by weight of the emulsion, or from about 70% to about 80%, or from about 70% to about 75%.

19. The use as recited in any one of claims 15 to 18 wherein the amylopectin is selected from the group consisting of waxy corn, waxy potato, waxy tapioca, and waxy rice and mixtures thereof.

20. The use as recited in any one of claims 15 to 19 wherein the emulsion does not comprise a hydrocolloid or modified starch.

21. The use as recited in any one of claims 15 to 20 having pH of less than 5 or from about 3 to about 5, or from about 2.5 to about 7.

22. The use as recited in any one of claims 15 to 21 wherein the emulsion has a viscosity of from about 10.000 to about 50.000 cP, or from about 15.000 to about 30.000 cP, or from about 15.000 to about 25.000 cP.

23. The use as recited in any one of claims 15 to 22 wherein the emulsion has a mean oil droplet size from about 10 microns to about 20 microns, or from about 10 microns to about 17 microns or from about 10 microns to about 15 microns, or less than about 10 microns or from about 5 to about 10 microns.

24. The use as recited in any one of claims 15 to 23 wherein the emulsion has a variation of a mean oil droplet size of less that changes by less than about 5 microns over 1 month’s storage at one or more of 5° C. or 25° C.

25. The use as recited in any one of claims 15 to 24 wherein the emulsion has variation of a mean oil droplet size that changes by less than about less than about 5 microns over 6 months when stored at one or more of 5° C. or 25° C.

26. The use as recited in any one of claims 15 to 25 wherein the gelatinized but otherwise unmodified amylopectin to reduce the protein used in an oil-in-water emulsion.

27. A method of making emulsion comprising: mixing an oil in an amount from about 65% to about 80% by weight of the emulsion, or from about 70% to about 80%, or from about 70% to about 75%; an aqueous ingredient, and an emulsifier mixture in an amount from 10% to 30% of the of the emulsion, or about 10% to about 25%, or about 15% to about 25%, or about 15% to about 20% wherein the emulsifier mixture is an aqueous mixture comprising: an unhydrolyzed soluble pulse, or pea, or chickpea protein in an amount of about 1% to about 3% of the emulsifier mixture; and a dissolved unmodified amylopectin in an amount of about 2% to about 5% or from about 2% to about 4%, or about 2.5% to about 3.5% of the emulsifier mixture; and wherein the emulsion does not comprise egg; wherein preferably the unhydrolyzed soluble protein is pea protein or chickpea protein, and wherein, more preferably, the unhydrolyzed soluble is pea protein.

28. The method of claim 27 wherein the emulsifier mixture is provided by an aqueous solution.

29. The method of claim 27 or 28 wherein the emulsifier mixture is obtained by heating a granular amylopectin in an aqueous solution comprising pulse, or pea, or chickpea protein solution for enough time to gelatinize the amylopectin.

30. The method of any one of claims 27 to 29 wherein the emulsifier mixture is obtained by heating an aqueous mixture of pulse, or pea, or chickpea protein solution and amylopectin at a temperature of from about 90° C. to about 100° C. for at least about 15 minutes, or at about least 20 minutes.

31. The method of any one of claims 27 to 30 wherein the emulsifier mixture is obtained by mixing a gelatinized amylopectin with aqueous solution comprising chickpea protein or pea protein solution, wherein, preferably the aqueous solution comprises pea protein.

32. The method of any one of claims 27 to 31 wherein the amylopectin is selected from the group consisting of waxy corn, waxy tapioca, waxy rice, and waxy potato and mixtures thereof.

33. The method of any one of claims 27 to 32 wherein the emulsifier mixture is obtained by mixing gelatinized amylopectin with aqueous chickpea solution, which has a Brix of from about 5 ° to about 10 °, or from about 5 ° to about 9 °, or from about 5 ° to about 8 °, or from about 5 ° to about 7 °, or from about 6 ° to about 8 °, or from about 6 ° to about 9 °, or from about 6 ° to about 8 ° Brix.

34. The method of any one of claims 27 to 33 wherein the emulsifier mixture has a total dissolved solids content of from about 5% to about 15% or from about 5% to about 10%.

35. The method of any one of claims 27 to 34 wherein the method does not comprise adding hydrocolloid or modified starch to the emulsion.

36. The method of any one of claims 27 to 35 wherein the method does not comprise adding a hydrocolloid or modified starch.

37. The method of any one of claims 27 to 36 wherein the method does not comprise adding a starch other than the solubilized amylopectin.

38. A pulse protein-based emulsifier composition comprising: an unhydrolyzed soluble pulse, or pea, or chickpea protein in an amount of about 1% to about 3% of the emulsifier mixture; and a dissolved unmodified amylopectin in an amount of about 2% to about 5% or from about 3% to about 4% of the emulsifier mixture; wherein the composition is an aqueous composition.

39. The composition of claim 38 wherein the unhydrolyzed soluble pulse, or pea, or chickpea protein is provided by an aqueous chickpea protein solution or aqueous pea solution, wherein, wherein preferable by an aqueous pea solution.

40. The composition of claim 38 or 39 wherein the amylopectin is selected from the group consisting of waxy corn, waxy tapioca, waxy rice, and waxy potato and mixtures thereof.

41. The composition of any one of claims 38 to 40 having a total solids content of from about 5% to about 15% or from about 5% to about 10%.

42. The composition of any one of claims 38 to 40 wherein the composition does not comprise adding a hydrocolloid or modified starch.

43. The composition of any one of claims 38 to 41 wherein the composition does not comprise adding a starch other than the solubilized amylopectin.

44. The composition of any one of claims 38 to 42 consisting essentially of an aqueous chickpea protein solution, and the amylopectin.

45. The composition of claims 38 to 44 consisting of an aqueous chickpea protein solution and the amylopectin.

46. The composition of any one of claims 38 to 45 consisting essentially of an aqueous pea protein solution, and the amylopectin.

47. The composition of claims 38 to 46 consisting of an aqueous pea protein solution and the amylopectin.

48. A method of making an aqueous pulse protein-based emulsifier composition comprising: mixing an aqueous solution comprising an unhydrolyzed soluble chickpea protein or pea protein, in an amount of about 1% to about 3% of the emulsifier composition; an unmodified amylopectin in an amount of about 2% to about 5% or from about 3% to about 4% of the emulsifier composition; and heating the mixture at a temperature of from about 90° C. to about 100° C. for at least about 15 minutes, or at about least 20 minutes, so that the amylopectin is gelatinized and dissolved in the aqueous solution wherein, preferably the unhydrolyzed soluble protein is a pea protein.

49. The method of claim 48 wherein the aqueous solution comprising an unhydrolyzed soluble protein has a Brix of from about 5° to about 10°, or from about 5° to about 9°, or from about 5° to about 8°, or from about 5° to about 7°, or from about 6° to about 8°, or from about 6° to about 9°, or from about 6° to about 8° Brix.

50. The method of claim 48 or 49 wherein the composition has total solids content from about 5% and about 15%, or from about 5% to about 10%.

51. The method of any one of claims 48 to 50 wherein the method does not comprise adding a hydrocolloid, or modified starch.

52. The method of any one of claims 48 to 51 wherein the method does not comprise adding a starch other than the solubilized amylopectin.

53. An emulsion comprising: a) oil; b) water; c) unhydrolyzed soluble chickpea protein; d) and dissolved amylopectin an amount from about 0.10% to about 20.00% (w/w) of the emulsion, or from about 0.1% to about 10%, or from about 0.1% to about 5%, or from about 0.10% to about 0.60% (w/w), or from about 0.10% to about 0.50% (w/w), or from about 0.10% to about 0.40% (w/w), or from about 0.10% to about 0.30% (w/w), or from about 0.10% to about 0.20% (w/w).

54. The emulsion of claim 53 wherein the dissolved amylopectin is in an amount from about 0.20% to about 0.70% (w/w) of the emulsion, or from about 0.30% to about 0.70% (w/w), or from about 0.40% to about 0.70% (w/w), or from about 0.50% to about 0.70% (w/w) or from about 0.60% to about 0.70% (w/w).

55. The emulsion of claim 53 or 54 wherein the dissolved amylopectin in an amount from about 1% to about 15% (w/w), or about 5% to about 10%, or about 8% to about 12% by weight of the emulsion.

56. An emulsion comprising: a) an oil in an amount of from about 25% to about 50% or from about 25% to about 40% or from about 25% to about 35% b) an unhydrolyzed soluble chickpea protein in an amount of about 0.15% to about 1.0%, or about 0.15% to about 0.55%, or about 0.25% to about 0.45%, or about 0.30% to about 0.40% by weight of the emulsion; c) a dissolve, unmodified amylopectin in an amount of about 0.1% to about 1.0% by weight of the emulsion, or of about 0.2% to about 0.80% (w/w), or from about 0.4% to about 0.8% (w/w), or from about 0.5% to about 0.8% (w/w); and d) an aqueous ingredient; wherein the emulsion is egg free.

57. An emulsion or method of making an emulsion as described in any forgoing claim wherein the emulsion comprises from 1 to 10% of an inhibited starch, preferably a waxy cassava starch, and more preferably thermally inhibited starch waxy cassava starch.

58. A pulse protein-based emulsifier composition comprising: an unhydrolyzed soluble pulse, or pea, or chickpea protein in an amount of about 1% to about 3% of the emulsifier mixture; and a dissolved unmodified amylopectin in an amount of about 2% to about 5% or from about 3% to about 4% of the emulsifier mixture; wherein the composition is an aqueous composition; wherein, optionally, is provided by an aqueous chickpea protein solution or aqueous pea solution, wherein, wherein preferable by an aqueous pea solution; wherein, optionally, the amylopectin is selected from the group consisting of waxy corn, waxy tapioca, waxy rice, and waxy potato and mixtures thereof.

59. The composition of claim 58 having a total solids content of from about 5% to about 15% or from about 5% to about 10%.

60. The composition of claim 58 or 59 wherein the composition does not comprise a hydrocoll58oid or modified starch.

61. The composition of any one of claims 58 to 60 wherein the composition does not comprise adding a starch other than the solubilized amylopectin.

62. The composition of any one of claims 58 to 61 consisting essentially of an aqueous chickpea protein solution, and the amylopectin.

63. The composition of any one of claims 58 to 62 consisting essentially of an aqueous pea protein solution, and the amylopectin.

64. An emulsion of oil and water comprising: oil in an amount from about 65% to about 80% by weight of the emulsion, or from about 70% to about 80%, or from about 70% to about 75%; an unhydrolyzed soluble pulse, or pea, or chickpea protein in an amount of about 0.15% to about 1.0% or from 0.15% to about 0.55%, or about 0.25% to about 0.45%, or about 0.30% to about 0.40% by weight of the emulsion; a dissolved unmodified amylopectin in an amount of about 0.1% to about 1.0% by weight of the emulsion, or of about 0.2% to about 0.80% (w/w), or from about 0.4% to about 0.8% (w/w), or from about 0.5% to about 0.8% (w/w); and an aqueous ingredient; wherein the emulsion is egg free wherein, preferably, the unhydrolyzed soluble protein is pea protein or chickpea protein, and more preferably is a pea protein; wherein, preferably, the unhydrolyzed soluble protein is in an amount of about 0.4% to about 0.5% and the dissolved unmodified amylopectin is in amount of about 0.4% to about 0.6%; and wherein, preferably, the amylopectin is from waxy corn, waxy potato, waxy tapioca, or waxy rice or mixtures thereof.

65. The emulsion of claim 64 wherein the emulsion does not comprise a hydrocolloid or modified starch.

66. The emulsion of claim 64 or 65 wherein the emulsion does not comprise a starch other than the solubilized amylopectin.

67. The emulsion of any one of claims 64 to 66 having a pH of less than 5 or from about 3 to about 5, or from about 2.5 to about 7.

68. The emulsion of any one of claims 64 to 67 having a mean oil droplet size from about 5 microns to about 15 microns or from about 5 to about 10 microns.

69. The emulsion of any one of claims 64 to 68 wherein the mean oil droplet size from about 5 microns to about 15 microns or from about 5 to about 10 microns after 1-month storage.

70. The emulsion of any one of claims 64 to 69 having a variation of a mean oil droplet from about 5 microns to about 15 microns or from about 5 to about 10 microns over 1-month when stored at one or more of 5° C. or 25° C.

71. The emulsion of claims 64 to 70 having variation of a mean oil droplet size from about 5 microns to about 15 microns or from about 5 to about 10 microns over 6 months when stored at one or more of 5° C. or 25° C.

72. A method of making an aqueous pulse protein-based emulsifier composition comprising: obtaining a mixture comprising: i) an aqueous solution comprising an unhydrolyzed soluble chickpea protein or pea protein, in an amount of about 1% to about 3% of the emulsifier composition; and ii) an unmodified gelatinized amylopectin in an amount of about 2% to about 5% or from about 3% to about 4% of the emulsifier composition; wherein, preferably, the unhydrolyzed soluble protein is a pea protein.

73. The method of claim 72 wherein obtaining the mixture comprises mixing the aqueous solution comprising the unhydrolyzed soluble chick pea protein or pea protein with an unmodified amylopectin and heating the aqueous solution at a temperature of from about 90° C. to about 100° C. for at least about 15 minutes, or at about least 20 minutes, so that the amylopectin is gelatinized and dissolved in the aqueous solution.

74. The method of claim 72 or 73 wherein the aqueous solution comprising an unhydrolyzed soluble protein has a Brix of from about 5° to about 10°, or from about 5° to about 9°, or from about 5° to about 8°, or from about 5° to about 7°, or from about 6° to about 8°, or from about 6° to about 9°, or from about 6° to about 8° Brix.

75. The method of claim 72 or 74 wherein the composition has total solids content from about 5% and about 15%, or from about 5% to about 10%.

76. The method of any one of claims 72 to 75 wherein the method does not comprise adding a hydrocolloid, or modified starch.

77. The method of any one of claims 72 to 76 wherein the method does not comprise adding a starch other than the unmodified gelatinized amylopectin.

78. A method or composition as described in any forgoing claim using an aqueous unhydrolyzed soluble chickpea protein.

79. A method or composition as described in any foregoing claims using an aqueous unhydrolyzed soluble pea protein.

80. A chickpea protein-based emulsifier composition comprising: an unhydrolyzed soluble chickpea protein in an amount of about 1% to about 3% of the emulsifier mixture; and a dissolved unmodified amylopectin in an amount of about 2% to about 5% or from about 3% to about 4% of the emulsifier mixture; wherein the composition is an aqueous composition; wherein, optionally, the amylopectin is selected from the group consisting of waxy corn, waxy tapioca, waxy rice, and waxy potato and mixtures thereof.

81. The composition of claim 80 having a total solids content of from about 5% to about 15% or from about 5% to about 10%.

82. The composition of claim 80 or 81 wherein the composition does not comprise a hydrocolloid or modified starch.

83. The composition of any one of claims 80 to 82 wherein the composition does not comprise adding a starch other than the solubilized amylopectin.

84. The composition of any one of claims 80 to 83 consisting essentially of an aqueous chickpea protein solution, and the amylopectin.

85. An emulsion of oil and water comprising: oil in an amount from about 65% to about 80% by weight of the emulsion, or from about 70% to about 80%, or from about 70% to about 75%; an unhydrolyzed soluble pulse, or pea, or chickpea protein in an amount of about 0.15% to about 1.0% or from 0.15% to about 0.55%, or about 0.25% to about 0.45%, or about 0.30% to about 0.40% by weight of the emulsion; a dissolved unmodified amylopectin in an amount of about 0.1% to about 1.0% by weight of the emulsion, or of about 0.2% to about 0.80% (w/w), or from about 0.4% to about 0.8% (w/w), or from about 0.5% to about 0.8% (w/w); and an aqueous ingredient; wherein the emulsion is egg free wherein, preferably, the unhydrolyzed soluble protein is pea protein or chickpea protein, and more preferably is a pea protein; wherein, preferably, the unhydrolyzed soluble protein is in an amount of about 0.4% to about 0.5% and the dissolved unmodified amylopectin is in amount of about 0.4% to about 0.6%; and wherein, preferably, the amylopectin is from waxy corn, waxy potato, waxy tapioca, or waxy rice or mixtures thereof.

86. The emulsion of claim 85 wherein the emulsion does not comprise a hydrocolloid or modified starch.

87. The emulsion of claim 85 or 86 wherein the emulsion does not comprise a starch other than the solubilized amylopectin.

88. The emulsion of any one of claims 85 to 87 having a pH of less than 5 or from about 3 to about 5, or from about 2.5 to about 7.

89. The emulsion of any one of claims 85 to 88 having a mean oil droplet size from about 5 microns to about 15 microns or from about 5 to about 10 microns.

90. The emulsion of any one of claims 85 to 89 wherein the mean oil droplet size from about 5 microns to about 15 microns or from about 5 to about 10 microns after 1-month storage.

91. The emulsion of any one of claims 85 to 90 having a variation of a mean oil droplet from about 5 microns to about 15 microns or from about 5 to about 10 microns over 1-month when stored at one or more of 5° C. or 25° C.

92. The emulsion of claims 85 to 91 having variation of a mean oil droplet size from about 5 microns to about 15 microns or from about 5 to about 10 microns over 6 months when stored at one or more of 5° C. or 25° C.

93. A method of making an aqueous pulse protein-based emulsifier composition comprising: obtaining a mixture comprising: i) an aqueous solution comprising an unhydrolyzed soluble chickpea protein in an amount of about 1% to about 3% of the emulsifier composition; and ii) an unmodified gelatinized amylopectin in an amount of about 2% to about 5% or from about 3% to about 4% of the emulsifier composition; wherein, preferably, the unhydrolyzed soluble protein is a pea protein.

94. The method of claim 93 wherein obtaining the mixture comprises mixing the aqueous solution comprising the unhydrolyzed soluble chick pea protein with an unmodified amylopectin and heating the aqueous solution at a temperature of from about 90° C. to about 100° C. for at least about 15 minutes, or at about least 20 minutes, so that the amylopectin is gelatinized and dissolved in the aqueous solution.

95. The method of claim 93 or 94 wherein the aqueous solution comprising an unhydrolyzed soluble protein has a Brix of from about 5° to about 10°, or from about 5° to about 9°, or from about 5° to about 8°, or from about 5° to about 7°, or from about 6° to about 8°, or from about 6° to about 9°, or from about 6° to about 8° Brix.

96. The method of any one of claims 93 to 95 wherein the composition has total solids content from about 5% and about 15%, or from about 5% to about 10%.

97. The method of any one of claims 93 to 96 wherein the method does not comprise adding a hydrocolloid, or modified starch.

98. The method of any one of claims 93 to 97 wherein the method does not comprise adding a starch other than the unmodified gelatinized amylopectin.

99. A pulse protein-based emulsifier composition comprising: an unhydrolyzed soluble pea protein in an amount of about 1% to about 3% of the emulsifier mixture; and a dissolved unmodified amylopectin in an amount of about 2% to about 5% or from about 3% to about 4% of the emulsifier mixture; wherein the composition is an aqueous composition wherein, optionally, the amylopectin is selected from the group consisting of waxy corn, waxy tapioca, waxy rice, and waxy potato and mixtures thereof.

100. The composition of claim 99 having a total solids content of from about 5% to about 15% or from about 5% to about 10%.

101. The composition of claim 99 or 100 wherein the composition does not comprise a hydrocolloid or modified starch.

102. The composition of any one of claims 99 to 101 wherein the composition does not comprise adding a starch other than the solubilized amylopectin.

103. The composition of any one of claims 99 to 102 consisting essentially of an aqueous pea protein solution, and the amylopectin.

104. An emulsion of oil and water comprising: oil in an amount from about 65% to about 80% by weight of the emulsion, or from about 70% to about 80%, or from about 70% to about 75%; an unhydrolyzed soluble pea protein in an amount of about 0.15% to about 1.0% or from 0.15% to about 0.55%, or about 0.25% to about 0.45%, or about 0.30% to about 0.40% by weight of the emulsion; a dissolved unmodified amylopectin in an amount of about 0.1% to about 1.0% by weight of the emulsion, or of about 0.2% to about 0.80% (w/w), or from about 0.4% to about 0.8% (w/w), or from about 0.5% to about 0.8% (w/w); and an aqueous ingredient; wherein the emulsion is egg free wherein, preferably, the unhydrolyzed soluble protein is in an amount of about 0.4% to about 0.5% and the dissolved unmodified amylopectin is in amount of about 0.4% to about 0.6%; and wherein, preferably, the amylopectin is from waxy corn, waxy potato, waxy tapioca, or waxy rice or mixtures thereof.

105. The emulsion of claim 104 wherein the emulsion does not comprise a hydrocolloid or modified starch.

106. The emulsion of claim 104 or 105 wherein the emulsion does not comprise a starch other than the solubilized amylopectin.

107. The emulsion of any one of claims 104 to 106 having a pH of less than 5 or from about 3 to about 5, or from about 2.5 to about 7.

108. The emulsion of any one of claims 104 to 107 having a mean oil droplet size from about 5 microns to about 15 microns or from about 5 to about 10 microns.

109. The emulsion of any one of claims 104 to 108 wherein the mean oil droplet size from about 5 microns to about 15 microns or from about 5 to about 10 microns after 1-month storage.

110. The emulsion of any one of claims 104 to 109 having a variation of a mean oil droplet from about 5 microns to about 15 microns or from about 5 to about 10 microns over 1-month when stored at one or more of 5° C. or 25° C.

111. The emulsion of claims 104 to 110 having variation of a mean oil droplet size from about 5 microns to about 15 microns or from about 5 to about 10 microns over 6 months when stored at one or more of 5° C. or 25° C.

The emulsion of any one of claims 104 to 108 wherein the mean oil droplet size from about 5 microns to about 15 microns or from about 5 to about 10 microns after 1-month storage.

110. The emulsion of any one of claims 104 to 109 having a variation of a mean oil droplet from about 5 microns to about 15 microns or from about 5 to about 10 microns over 1-month storage at one or more of 5° C. or 25° C.

111. The emulsion of claims 104 to 110 having variation of a mean oil droplet size from about 5 microns to about 15 microns or from about 5 to about 10 microns after 6 months when stored at one or more of 5° C. or 25° C.

112. A method of making an aqueous pulse protein-based emulsifier composition comprising: obtaining a mixture comprising: i) an aqueous solution comprising an unhydrolyzed soluble pea protein, in an amount of about 1% to about 3% of the emulsifier composition; and ii) an unmodified gelatinized amylopectin in an amount of about 2% to about 5% or from about 3% to about 4% of the emulsifier composition.

113. The method of claim 112 wherein the aqueous solution comprising an unhydrolyzed soluble protein has a Brix of from about 5° to about 10°, or from about 5° to about 9°, or from about 5° to about 8°, or from about 5° to about 7°, or from about 6° to about 8°, or from about 6° to about 9°, or from about 6° to about 8° Brix.

114. The method of any one of claims 112 to 113 wherein the composition has total solids content from about 5% and about 15%, or from about 5% to about 10%.

115. The method of any one of claims 112 to 114 wherein the method does not comprise adding a hydrocolloid, or modified starch.

116. The method of any one of claims 112 to 115 wherein the method does not comprise adding a starch other than the unmodified gelatinized amylopectin.

The technology is further described by the following examples, which are intended to be illustrative and are not intended to limit the full scope of the claims or their equivalents.

### Example 1 - Formulations

Table 1a discloses a non-limiting formula of a low-fat emulsion.

TABLE 1a

Low-fat emulsion formula: Formula 1

| Paste Ingredients | wt.% |
|---|---|
| Water | 43.0925 |
| Sugar | 11.51 |
| Vinegar (120 Grain) | 8.13 |
| Dry thermally inhibited starch | 4.5 |
| Aqueous plant-based emulsifier (solids content; including protein and solubilized amylopectin) | 1.0 |
| Salt | 1.69 |
| Preservatives | 0.0775 |
| Soybean Oil | 30.00 |
| Total | 100 |

Note that within low fat emulsions, viscosity that is lost by fact is provided use of thermally inhibited starches. In this case the thermally inhibited starch is used to provide soluble amylopectin. Commonly more highly inhibited thermally inhibited waxy starches would be used because they better resist gelatinization and dissolution in an acidic emulsion. So these highly insoluble thermally inhibited starches are better able to supply viscosity to the emulsion, which is a different effect than providing stability against oil and water separation as is done by dissolved amylopectin.

Table 1b discloses a non-limiting formula for a high fat emulsion

TABLE 1b

High-fat emulsion formula

| Ingredient | wt% |
|---|---|
| Water | 3.2 |
| Sugar | 3 |
| Vinegar (120 Grain) | 3 |
| Potassium Sorbate | 0.1 |
| Dry starch | 0.7 |
| Salt | 1 |
| Aqueous unhydrolyzed chickpea-protein | 18 |
| Soybean Oil | 71 |
| Total | 100 |

### Example 2 - Procedures

Applicants evaluated the viscosity and the stability of emulsions including emulsions of oil and water made using both dilute and concentrated plant-based emulsifiers. It was observed that high-oil (greater than about 70%) compositions using dilute plant-based emulsifiers required additional stabilization provided by the addition of an inhibited starch. It was further observed that compositions using concentrated plant-based emulsifiers did not require use of starch stabilizers despite having equal liquid content. Such observations were made according to the following procedures.

Viscosity was measured using a Brookfield DV2T w/ heliopath moving upward using a T spindle C for 30 seconds at 20 RPM.

Mean droplet size was measured using a Beckman Coulter LS 13 320 SW Laser Based Particle Size Analyzer.

Brix (referring to a refractometric measurement of solids in solution using the Brix scale for dissolved sugars), of a solution was measured using a refractometer.

Soluble content of solutions was measured using a polarimeter, e.g. Autopol IV Automatic Polarimeter, Rudolph Research Analytical, Flanders, NJ.

Protein content of a solution or emulsion can be determined using any one of various nitrogen content calculations known in the art, for example, using a Dumas calculation method using a LECO analyzer.

Total solids content was determined by measuring the initial weight of a 1 gram sample of solution with starch, measuring the residual weight of the sample after drying at 130° C. for 4 hours, and comparing their weights. Percent solids content is calculated as the initial weight the sample/the residual weight of the sample x 100.

Emulsions were made by first blending all dry ingredients. Water and vinegar were combined in a conventional kitchen stand mixer mixing bowl. The dry blend was added to the water and vinegar mixture and mixed until homogenous. Oil was slowly added while mixing at medium speed. The mass was then transferred to a Scott Turbon mixer for high shear homogenization. (30 hertz for 2 minutes).

### Example 3 - Long Term Stability of High-Fat Emulsions

Emulsions were made using the high-fat emulsion formulation reported in Table 1b above. Starches were cooked 12 hours prior to making the emulsion. To cook them, the starches were dispersed in an aqueous solution in (separate from the unhydrolyzed chickpea-protein component) and the dispersion was cooked in hot water bath for 10 minutes at 210° F. (about 99° C.). Starches evaluated for ability to stabilize the emulsions were two variants of thermally inhibited starches: a highly inhibited waxy corn starch, and an intermediately inhibited waxy corn starch.

High fat emulsions were made as follows. Dry ingredients, including starch, were mixed. Separately, dilute plant-based emulsifier and vinegar were combined in a stand mixer’s mixing bowl. While mixing, dry ingredients were added to the emulsifier and vinegar mix until the dry ingredients were completely dispersed, an emulsion formed, and the emulsion appeared homogenous. The emulsion was then transferred to a high-speed mixer where it was mixed for 2 minutes at 30 Hz. The emulsions were placed in jars for storage at room temperature (25° C.) or refrigerated (5° C.) and their mean oil droplet sizes were determined at different time points after storage.

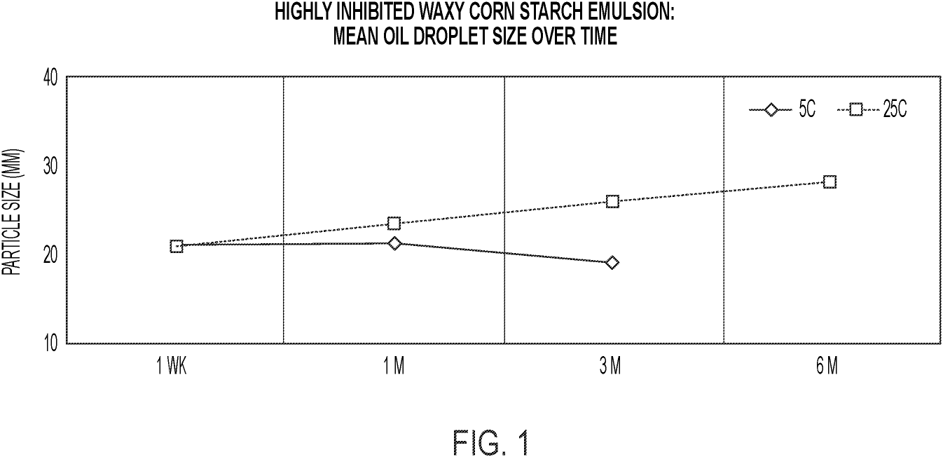

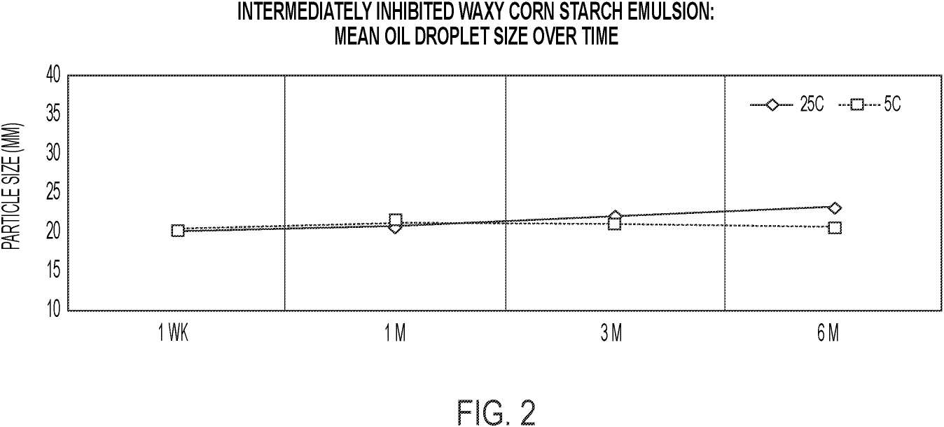

With reference to FIGS. 1 and 2 it is seen that emulsions made with the intermediately thermally inhibited waxy corn starch had much less variation in oil droplet size over time compared to emulsions made with the highly thermally inhibited waxy corn starch. Thermal inhibition is process of functionalizing by cooking anhydrous buffer treated starches, the obtained starches behave like chemically crosslinked starches without being crosslinked.

### Example 4 - Soluble Content of Various Cooked Waxy Starches

The soluble content of various cooked waxy starches was measured as follows. In a glass beaker, 2 grams of starch was added to an aqueous solution buffered to either pH 6 or pH 3 to make a 100 g solution. Starch was dispersed in solution using mixer. The solution was continuously mixed during cooking in a stoppered beaker submerged in a boiling water bath (100° C.) for 20 minutes. The dispersion was then allowed to cool for 1 hour. Samples were removed from beaker diluted to 1% using the buffered solution (same as for initial dispersion). Starch in dispersion was transferred to a graduated cylinder and allowed to settle for up to 72 hours (until swelling of starch stopped). Drops of supernatant were removed and measured for soluble material content using a polarimeter.

Using the above described method, the soluble content of waxy corn starch, intermediately thermally inhibited waxy corn starch and highly thermally inhibited waxy corn starch was determined. Results are reported in Table 2 below.

TABLE 2

Soluble Content of Various Waxy Corn Starches

| Starch | Solution pH | Soluble Content (%) |
|---|---|---|
| Waxy Corn starch | 6 | 50.0 |
| | 3 | 50.0 |
| Intermediately inhibited, thermally inhibited waxy corn starch | 6 | 8.0 |
| | 3 | 17.0 |
| Highly inhibited, thermally inhibited waxy corn starch | 6 | 6.6 |
| | 3 | 10.8 |
| Lowly inhibited, thermally inhibited waxy tapioca starch | 6 | 1.4 |
| | 3 | 6.5 |
| Intermediately inhibited, thermally inhibited waxy tapioca starch | 6 | 1.2 |
| | 3 | 8.7 |
| Highly inhibited, thermally inhibited waxy tapioca starch | 6 | 1.2 |
| | 3 | 19.0 |

As shown, uninhibited starches and less thermally inhibited waxy starches have higher soluble amylopectin content in all cases, but particularly so at low pH (pH 6 vs pH 3). Starches can be inhibited to varying degrees according to the methods described in WO95/04082. It should be noted that the absolute degree of inhibition is not relevant other to show that less inhibited starches have higher soluble starch content, which because the starches are waxy starches the starch is entirely amylopectin. As shown herein, emulsions made with higher amounts of dissolved e amylopectin have smaller mean droplet size than emulsion with less dissolved amylopectin. For example this can be seen with reference to FIGS. 1 and 2 it shown, therefore, that emulsions having higher soluble amylopectin content were more stable over time.

### Example 5 - Mean Oil Droplet Size of High-fat Emulsions Made With Various Cooked Waxy Starches

The observations from FIGS. 1 and 2 are further expanded in Table 3 below. Table 3 shows the viscosity and mean oil droplet size of seven sample high-fat oil-in-water emulsions made with seven different cooked starches, using the formulation listed in Table 1b.

The emulsions were made using the formula of Table 1b and were made as follows. Dry ingredients, including starch were mixed. Separately, dilute plant-based emulsifier and vinegar were combined in a stand mixer’s mixing bowl. While mixing, dry ingredients were added to the emulsifier and vinegar mix until the dry ingredients were completely dispersed, an emulsion form, and the emulsion appeared homogenous. The emulsion was then transferred to a high-speed mixer where it was mixed for 2 minutes at 30 Hz. Emulsions were placed in jars for storage.

The seven different starches used in the seven emulsion samples were as follows. Starches used in emulsion samples 1 and 2 were pregelatinized samples that were not further cooked. Starches used in emulsion samples 3 through 7 were cooked at least 12 hours prior to making the emulsion. All starches used in emulsion samples 3 to 7 were cooked by dispersing starch in aqueous solution in a container and cooking in hot water bath for 10 minutes at 210° F. (about 99° C.). Beyond this process, the starch used in individual samples were also treated as follows:

Starch of sample 1 was a native waxy corn starch that was pregelatinized by spray cooking.

Starch of sample 2 was an intermediately inhibited, thermally inhibited waxy corn starch that was pregelatinized by spray cooking.

Starch of sample 3 was an intermediately inhibited, thermally inhibited waxy corn starch that is pregelatinized by spray cooking and then further cooked.

Starch of sample 4 was an intermediately inhibited, thermally inhibited waxy corn starch that is pregelatinized by spray cooking and then further cooked and sheared.

Starch of sample 5 was a highly inhibited, thermally inhibited waxy tapioca starch.

Starch of sample 6 was an intermediately inhibited, thermally inhibited waxy tapioca starch.

Starch of sample 7 was a lowly inhibited, thermally inhibited waxy tapioca starch.

Note that the starch of sample 3 used the same starting pregelatinized starch as sample 2 but further cooked the starch as described in this example. Also, the starch of sample 4 used the same starting starch of as the starch of sample 3, but further sheared the starch prior to being mixed to form the emulsion as described in this specification.

Mean oil droplet size of fresh oil-in-water emulsions and the viscosity of fresh oil in water emulsions is reported Table 3 below.

TABLE 3

Mean Oil Droplet Size and Viscosity of Oil-in-Water Emulsions Using Different Starches

| Sample | Starch Type | Viscosity (cP) | Mean Oil Droplet Size (µM) |
|---|---|---|---|
| 1 | Spray cooked waxy corn starch | 16850 | 10.95 |
| 2 | Spray cooked, intermediately inhibited, thermally inhibited waxy corn starch | 35100 | 21.10 |
| 3 | Cooked, spray cooked, intermediately inhibited waxy corn starch | 34050 | 17.66 |
| 4 | Cooked, sheared, spray cooked, intermediately inhibited waxy corn starch | 22600 | 14.48 |
| 5 | Cooked, highly inhibited waxy tapioca starch | 27150 | 16.85 |
| 6 | Cooked, intermediately inhibited waxy tapioca starch | 28100 | 19.86 |
| 7 | Cooked, lowly inhibited waxy tapioca starch | 23450 | 13.85 |

It is noted that the high fat emulsions of this example, as described in Table 1b, comprise vinegar and so are acidic emulsions. It is further noted that inhibition of starch slows the swelling of the starch and makes it more resistant to granular disintegration and solubilization of amylopectin than non-inhibited starch as used in Sample 1. It is still further noted that less inhibited starches are less resistant to granular disintegration and solubilization of amylopectin than more inhibited starches. It is still further noted that smaller oil droplet size is an indicator of increased long-term stability of an emulsion.

With these observations in mind, it is seen in Table 3, that starches more likely to disintegrate during the emulsification so that amylopectin can dissolve in the aqueous component of the oil-in-water emulsion provided smaller mean oil droplet sizes. For example, Sample 1, spray cooked waxy corn starch, is not inhibited and so is less likely to withstand the shear of emulsification than the waxy corn inhibited starches or inhibited waxy tapioca starches. Among samples 2 through 4, it is seen that sample 4, the most harshly pretreated, being spray cooked, further cooked, and sheared, and so most likely to release amylopectin during emulsion, has the smallest droplet size. Among samples 5 to 7, it is further seen that the sample 7, the least inhibited starch, and per Table 2 having the least soluble amylopectin of samples 5 to 7, also provided the smallest mean oil droplet size.

### Example 6 - Oil in Water Emulsions Using an Unhydrolyzed Soluble Pea Protein Emulsifier

Emulsions were made using an unhydrolyzed soluble pea protein emulsifier and a dissolved unmodified amylopectin and were found to have a much smaller size oil droplet size compared to emulsions without the dissolved unmodified amylopectin, amounting to an increase in efficacy in the amount of 30% more relative to the amount of protein used. In all tests in this example dissolved soluble amylopectin is from gelatinized spray cooked native waxy corn starch.

Results were obtained by evaluation four different dosage levels (Samples 8 through 12). Formulations are recited in Table 4. As shown amylopectin was varied across samples 8 through 12 in the order of 0/0.⅟0.25/0.5/0.7% dosage. The amylopectin was added in addition to a standard target of 2% delivered solids. Emulsions are 70% oil. Unhydrolyzed soluble pea protein was provided in aqueous form and had 0.45% protein.

TABLE 4

70% Oil in Water Emulsion Formula Containing Unhydrolyzed Soluble Pea Protein and Dissolved Gelatinized Amylopectin

| | Sample 8 | Sample 9 | Sample 10 | Sample 11 | Sample 12 |
|---|---|---|---|---|---|
| Ingredient | Wt. % | Wt. % | Wt. % | Wt. % | Wt. % |
| Water | 8.3% | 8.2% | 8.05% | 7.8% | 7.6% |
| Sugar | 3% | 3% | 3% | 3% | 3% |
| Vinegar (120 Grain) | 3% | 3% | 3% | 3% | 3% |
| Dissolved gelatinized amylpectin | 0 | 0.1% | 0.25% | 0.5% | 0.7% |
| EDTA^ | 0.0007% | 0.0007% | 0.0007% | 0.0007% | 0.0007% |
| Potassium Sorbate | 0.1% | 0.1% | 0.1% | 0.1% | 0.1% |
| Table Salt | 1% | 1% | 1% | 1% | 1% |
| Aqueous unhydrolyzed soluble pea protein emulsifier | 14.5% | 14.5% | 14.5% | 14.5% | 14.5% |
| Soybean Oil | 70% | 70% | 70% | 70% | 70% |
| Total | 100% | 100% | 100% | 100% | 100% |

^Ethylenediaminetetraacetic acid

Table 5 reports the mean droplet sizes of Samples 8 to 12 measured at initial creation. As shown, additional levels of starch reduced the mean oil droplet size of the base formula the base formulation Sample 8.

TABLE 5

Mean Oil Droplet Size of 70% Oil in Water Emulsion Containing Unhydrolyzed Soluble Pea Protein and Dissolved Gelatinized Amylopectin

| Sample No# | Mean Droplet Size (µm) |
|---|---|
| Sample 8 | 11.892 |
| Sample 9 | 10.766 |
| Sample 10 | 9.719 |
| Sample 11 | 6.980 |
| Sample 12 | 7.070 |

It is observed that at a usage of 0.7% and 0.5% amylopectin the emulsions created were found to form oil droplet like an emulsions having higher pea protein content. This may be useful either to reduce overall protein usage or protect against emulsions stability due to variation in protein content of a aqueous pea protein emulsifier.

### Example 7 - Effect of Dissolved Unmodified Amylopectin in Oil In Water Emulsions

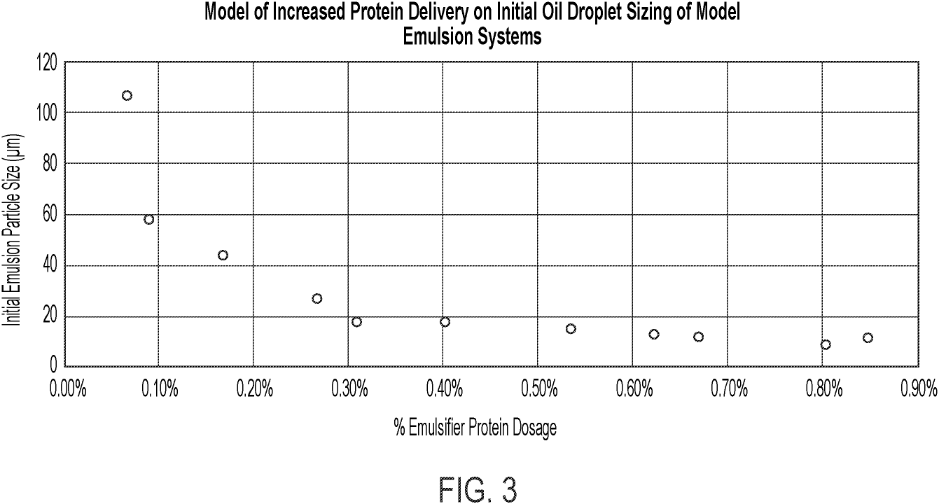

FIG. 3 plots on the y-axis, the mean oil droplet size on of emulsions made using unhydrolyzed soluble pulse protein and no dissolved unmodified amylopectin versus the weight percent of protein used on the x-axis (protein dosage). As seen as protein content increase, oil droplet sized decrease to a minimum oil droplet size at protein content above about 0.70%. Emulsions plotted in FIG. 3 used the formula of Sample 8, but varied protein content in the aqueous unhydrolyzed soluble pea protein emulsifier.

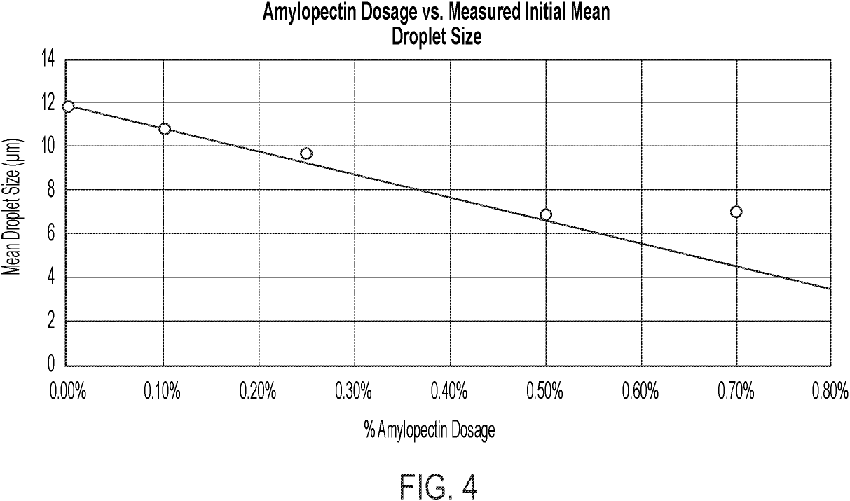

FIG. 4 plots the measured mean oil droplet size on the y-axis Samples 8 to 12 (all using 0.45% protein) versus the weight percent of dissolved amylopectin on the x-axis (amylopectin dosage). It is seen that oil droplet size decreases with increased amylopectin dosage until the oil droplet size reaches about 0.7 microns. Notably, Sample 6 has much higher droplet size mean than would be anticipated if the linear of decreased oil droplet sized apparent for emulsions having lower amylopectin dosage continued. Moreover, comparing FIGS. 3 and 4 it is seen that the minimum oil drop size obtainable by increasing amylopectin content and minimum oil droplet size obtainable by increasing protein content are essentially the same. This suggest that amylopectin is not acting as an as emulsifier in the sense that it is stabilizing the interface between the oil and water layers in the emulsions. Instead, the amylopectin seems assists the protein in obtaining a minimum oil droplet size, allowing for optimal emulsions to be made with less total protein needed.

1. A pulse protein-based emulsifier composition comprising:
a. an unhydrolyzed soluble pulse, or pea, or chickpea protein in an amount of about 1% to about 3% of the emulsifier mixture; and
b. a dissolved unmodified amylopectin in an amount of about 2% to about 5% or from about 3% to about 4% of the emulsifier mixture;
wherein the composition is an aqueous composition.

2. The composition of claim 1 having a total solids content of from about 5% to about 15% or from about 5% to about 10%.

3. The composition of claim 1 wherein the composition does not comprise a hydrocolloid or modified starch.

4. The composition claim 1wherein the composition does not comprise adding a starch other than the solubilized amylopectin.

5. The composition of claim 1 consisting essentially of an aqueous chickpea protein solution, and the amylopectin.

6. The composition of claim 1 consisting essentially of an aqueous pea protein solution, and the amylopectin.

7. An emulsion of oil and water comprising:
a. oil in an amount from about 65% to about 80% by weight of the emulsion ;
b. an unhydrolyzed soluble pulse, or pea, or chickpea protein in an amount of about 0.15% to about 1.0% by weight of the emulsion;
c. a dissolved unmodified amylopectin in an amount of about 0.1% to about 1.0% by weight of the emulsion, and
d. an aqueous ingredient;
wherein the emulsion is egg free.

8. The emulsion of claim 7 wherein the emulsion does not comprise a hydrocolloid or modified starch.

9. The emulsion of claim 7 wherein the emulsion does not comprise a starch other than the solubilized amylopectin.

10. The emulsion of claim 7 having a pH from about 2.5 to about 7.

11. The emulsion of claim 7 having a mean oil droplet size from about 5 microns to about 15 microns.

12. The emulsion of claim 7 wherein the mean oil droplet size from about 5 microns to about 15 microns after 1-month storage.

13. The emulsion of claim 7 having a variation of a over 1-month when stored at one or more of 5° C. or 25° C.

14. The emulsion of claim 7 having variation of a mean oil droplet size from about 5 microns to about 15 microns over 6 months when stored at one or more of 5° C. or 25° C.

15. A method of making an aqueous pulse protein-based emulsifier composition comprising:
obtaining a mixture comprising:
i) an aqueous solution comprising an unhydrolyzed soluble chickpea protein or pea protein, in an amount of about 1% to about 3% of the emulsifier composition; and
ii) an unmodified gelatinized amylopectin in an amount of about 2% to about 5% or from about 3% to about 4% of the emulsifier composition.

16. The method of claim 15 wherein obtaining the mixture comprises mixing the aqueous solution comprising the unhydrolyzed soluble chick pea protein or pea protein with an unmodified amylopectin and heating the aqueous solution at a temperature of from about 90° C. to about 100° C. for at least about 15 minutes, so that the amylopectin is gelatinized and dissolved in the aqueous solution.

17. The method of claim 15 wherein the aqueous solution comprising an unhydrolyzed soluble protein has a Brix of from about 5 ° to about 10 °.

18. The method of claim 15 wherein the composition has total solids content from about 5% and about 15%.

19. The method of claim 15 wherein the method does not comprise adding a hydrocolloid or modified starch.

20. The method of claim 15 wherein the method does not comprise adding a starch other than the unmodified gelatinized amylopectin.
